(19) United States
(12) Patent Application Publication
(10) Pub. No.: US 2008/0261647 A1
(43) Pub. Date: Oct. 23, 2008

(54) ELECTRONIC APPARATUS, CONTROL METHOD FOR ELECTRONIC APPARATUS AND CONTROL PROGRAM FOR ELECTRONIC APPARATUS

(76) Inventor: Kiyoshi Hamada, Kawasaki (JP)

Correspondence Address: HANIFY & KING PROFESSIONAL CORPORATION, 1875 K STREET, NW, SUITE 707, WASHINGTON, DC, 20006, US

(21) Appl. No.: 12/122,509

(22) Filed: May 16, 2008

Related U.S. Application Data
(63) Continuation of application No. PCT/JP2005/021712, filed on Nov. 25, 2005.

(51) Int. Cl. H04B 1/38; H04B 7/02

(52) U.S. Cl. 455/550.1; 375/267

(57) ABSTRACT

An electronic apparatus having a plurality of antennas and a plurality of telecommunication modules equipped with a telecommunication function for transmitting and receiving data by simultaneously using a plurality of antennas comprises: an antenna changeover switch for changing the connection of the antennas to the telecommunication modules; and a judgment circuit, which refers to an LED output-use signal output from each of the telecommunication modules used for turning on/off an LED in order to externally display an operation state, determines whether or not an antenna is connected to a telecommunication module in operation and thereby controls the antenna changeover switch.

### CROSS REFERENCE TO RELATED APPLICATION

This application is a continuation application of International PCT Application No. PCT/JP2005/021712 which was filed on Nov. 25, 2005.

### BACKGROUND OF THE INVENTION

1. Field of the Invention

The present invention relates to an electronic apparatus, control method for the electronic apparatus, and control program for the same; the present invention also relates, for example, to a technique effectively applicable to various electronic apparatuses such as a personal computer, a portable phone, and a portable information terminal, each of which includes a telecommunication module performing radio telecommunication by means of a multi-input multi-output (MIMO) technique.

2. Description of the Related Art

When an electronic apparatus such as a personal computer is equipped with a plurality of radio devices, each of which is commonly equipped with an antenna as disclosed in, for example, reference patent document 1.

Alternatively, when an antenna is shared by a plurality of radio devices, there is a known technique sharing the antenna by separating the frequencies used by the radio devices with a band pass filter as disclosed in reference patent document 2.

Further, there is a known technique for connecting one antenna to one radio device by using a high frequency wave switch when the antenna is shared by a plurality of the radio devices as disclosed in reference patent document 3.

In the meantime, recently gathering attention as a means of accomplishing stability in telecommunications, increasing transmission capacity of radio systems, and preventing telecommunication interruption, is a radio telecommunication technique called a multi-input multi-output (MIMO) which performs a parallel transmission in a space by using a plurality of antennas in both the transmission and reception sides.

In order to incorporate a plurality of MIMO radio functions in an electronic apparatus, a plurality of antennas are required for each radio function, and, therefore, it is predicted that the incorporation of the antennas is difficult for a small electronic device.

The method of sharing an antenna with a plurality of radio functions by separating radio signals by using a frequency filter as proposed by the aforementioned reference patent document 2 cannot be used for a MIMO radio device that transmits and receives radio waves of the same frequency band parallelly by way of a plurality of antennas.

Further, the aforementioned reference patent document 3 is premised on sharing one antenna by a plurality of radio functions and does not put forth a concept that would change over a plurality of antennas so as to be usable simultaneously.

Meanwhile, reference patent document 4 has disclosed a technique selectively using the one antenna with the best sensitivity among a plurality of antennas; the technique, however, is not applicable to a MIMO radio technique which uses a plurality of antennas simultaneously.

Patent document 1: WO2004/093346

Patent document 2: Laid-Open Japanese Patent Application Publication No. 2002-171315

Patent document 3: Laid-Open Japanese Patent Application Publication No. 2000-156651

Patent document 4: Laid-Open Japanese Patent Application Publication No. 2004-356798

### SUMMARY OF THE INVENTION

A purpose of the present invention is to provide a technique enabling an improvement of the performance of radio telecommunication for transmitting and receiving data by using a plurality of antennas without unnecessarily increasing the number of the antennas.

Another purpose of the present invention is to provide a technique enabling the miniaturization of an electronic apparatus comprising a telecommunication function performing a radio telecommunication for transmitting and receiving data by using a plurality of antennas.

A first aspect of the present invention provides an electronic apparatus comprising: a plurality of antennas; a first telecommunication module and a second telecommunication module, at least one of which performs radio telecommunications by simultaneously using a plurality of antennas among the antennas; and a connection changeover unit for changing over connections so that at least one of the antennas is connected to either the first or second telecommunication module.

A second aspect of the present invention provides the electronic apparatus according to the first aspect, wherein the connection changeover unit connects the antenna to either the first or second telecommunication module, either of which is judged to be in communication on the basis of an operation display signal indicating whether each of the first and second telecommunication module is in communication.

A third aspect of the present invention provides the electronic apparatus according to the first aspect, wherein the connection changeover unit connects the antenna to either the first or second telecommunication module, either of which is judged to be inferior in a telecommunication quality on the basis of telecommunication quality information indicating the telecommunication quality in each of the first and second telecommunication modules.

A fourth aspect of the present invention provides the electronic apparatus according to the first aspect, further comprising a priority order setup unit for setting a priority order of the first and second telecommunication modules, wherein the connection changeover unit connects the antenna to the first or second telecommunication module, either of which is higher in the priority order.

A fifth aspect of the present invention provides the electronic apparatus according to the first aspect, wherein the first telecommunication module is a wireless local area network (LAN) telecommunication module equipped with a multi-input multi-output (MIMO) radio telecommunication function and the second telecommunication module is a portable telephone-use telecommunication module equipped with a MIMO radio telecommunication function.

A sixth aspect of the present invention provides the electronic apparatus according to the first aspect, wherein the first telecommunication module is a multi-input multi-output (MIMO) radio telecommunication apparatus performing radio telecommunications by means of the MIMO system and the second telecommunication module is a global positioning system (GPS) reception apparatus or a broadcast reception apparatus, wherein the connection changeover unit changes the connection of the antenna, when it is connected to the second telecommunication module but the module is not being used, to the first telecommunication module.

A seventh aspect of the present invention provides a control method for an electronic apparatus, comprising: a first step for detecting the operation states of a first telecommunication module and of a second telecommunication module, at least one of which performs radio telecommunications by simultaneously using a plurality of antennas for transmitting and receiving data; and a second step for connecting an antenna shared by the first and second telecommunication modules to the first or second telecommunication module in accordance with the operation states.

An eighth aspect of the present invention provides the control method for the electronic apparatus according to the seventh aspect, wherein an operation display signal indicating whether or not each of the first and second telecommunication modules is in communication is detected as the operation state in the first step, and the antenna is connected to the first or second telecommunication module, either of which is judged to be in communication in the second step.

A ninth aspect of the present invention provides the control method for the electronic apparatus according to the seventh aspect, wherein telecommunication quality information indicating a telecommunication quality in each of the first and second telecommunication modules is detected as the operation state in the first step, and the antenna is connected to the first or second telecommunication module, either of which is judged to be inferior in the telecommunication quality in the second step.

A tenth aspect of the present invention provides the control method for the electronic apparatus according to the seventh aspect, wherein a telecommunication cost of each of the first and second telecommunication modules is detected as the operation state in the first step, and the antenna is connected, at a higher priority, to the first or second telecommunication module, either of which has a lower telecommunication cost in the second step.

An eleventh aspect of the present invention provides the control method for the electronic apparatus according to the seventh aspect, wherein the first telecommunication module is a multi-input multi-output (MIMO) radio telecommunication apparatus performing radio telecommunications by means of the MIMO system and the second telecommunication module is a global positioning system (GPS) reception apparatus or a broadcast reception apparatus, wherein whether or not the second telecommunication module is in use is discerned in the first step, and the antenna, connected to the second telecommunication module, is changed over to connect to the first telecommunication module if the second telecommunication module is judged to be not in use in the second step.

A twelfth aspect of the present invention provides a computer-readable storage medium storing a control program for use in an electronic apparatus which comprises a first telecommunication module and a second telecommunication module, at least one of which performs radio telecommunications for transmitting and receiving data by using a plurality of antennas simultaneously, wherein the control program makes the electronic apparatus execute a first step for detecting the operation states of the first and second telecommunication modules, and a second step for connecting an antenna shared by the first and second telecommunication modules to the first or second telecommunication module in accordance with the operation states.

A thirteenth aspect of the present invention provides the storage medium according to the twelfth aspect, wherein telecommunication quality information indicating a telecommunication quality in each of the first and second telecommunication modules is detected as the operation state in the first step, and the antenna is connected to the first or second telecommunication module, either of which is judged to be inferior in the telecommunication quality in the second step.

A fourteenth aspect of the present invention provides the storage medium according to the twelfth aspect, wherein a telecommunication cost of each of the first and second telecommunication modules is detected as the operation state in the first step, and the antenna is connected, at a higher priority, to the first or second telecommunication module, either of which has a lower telecommunication cost in the second step.

The above noted aspects of the present invention are contrived to connect an antenna shared by a plurality of radio devices (i.e., telecommunication modules) incorporated in, for example, an electronic apparatus automatically connected to a radio device in operation, and thereby the present invention implements a radio telecommunication by means of a MIMO system.

The operation state of an individual radio base station is judged by the output signal used for turning on an indicator lamp such as a light emitting diode (LED) indicating that the respective telecommunication module is in communication (that is, in session) (i.e., an access point connection in the case of a wireless LAN and a dial-up connection in the case of a radio telephone function such as the code division multiple access (CDMA)), and a shared antenna is connected to the telecommunication module in session.

Alternatively, the shared antenna is automatically assigned to the telecommunication module in which the reception radio wave is relatively weak in accordance with telecommunication quality such as the intensity of a radio wave received by the built-in telecommunication module and thereby the radio telecommunication capacity is reinforced.

The intensity of a reception radio wave is judged by comparing each respective piece of information reported from an individual telecommunication module, such as reception sensitivity, to a telecommunication control program such as a driver program managing the aforementioned individual telecommunication module. Then, the control of a changeover switch, by way of a built-in control circuit (e.g., a general purpose input/output (GPIO) of an application specific integration (ASIC)), implements, on the basis of the comparison result, a changeover operation for connecting the shared antenna to a telecommunication module to be used.

The aspects of the present invention are contrived to change over the connection of the shared antenna to a telecommunication module in need of improvement in, for example, telecommunication speed, thereby transmitting and receiving different pieces of data in parallel from plural antennas by means of the MIMO system and accordingly making it possible increase data transmission speed proportionately with the number of antennas in use.

Further, the reception sensitivity of the telecommunication module to which a shared antenna is assigned is improved in proportion to the number of antennas in use by transmitting and receiving the same data through a plurality of antennas by means of the MIMO system, and thereby the communication distance is increased and additionally communication interrupt is suppressed.

As such, it is possible to reduce the number of antennas and to change over the connection of a shared antenna among a plurality of telecommunication modules automatically in accordance with the situation, thereby operating the telecommunication module as the MIMO system in accordance with the telecommunication situation and enhancing telecommunication performance.

That is, it is possible to improve wireless telecommunication performance by means of the MIMO system using a plurality of antennas simultaneously without needlessly increasing the number of antennas.

In other words, the miniaturization of an electronic apparatus equipped with a telecommunication function performing a radio telecommunication by means of the MIMO system is accomplished.

### BRIEF DESCRIPTION OF THE DRAWINGS

FIG. 1 is a block diagram exemplifying the configuration of an electronic apparatus according to the preferred embodiment of the present invention;

FIG. 2 is a block diagram exemplifying a part of the electronic apparatus, in further detail, according to the preferred embodiment of the present invention;

FIG. 3 is a conceptual diagram showing an electronic apparatus that is a modified embodiment based on the preferred embodiment of the present invention;

FIG. 4 shows an electronic apparatus that is a modified embodiment based on the preferred embodiment of the present invention, the control method used for the electronic apparatus, and a flow chart exemplifying the operation of the control program used for the electronic apparatus;

FIG. 5 is a conceptual diagram of an electronic apparatus that is another modified embodiment based on the preferred embodiment of the present invention;

FIG. 6 shows an electronic apparatus that is another modified embodiment based on a preferred embodiment of the present invention, the control method used for the electronic apparatus, and a flow chart exemplifying the operation of the control program used for the electronic apparatus; and

FIG. 7 is a conceptual diagram showing an electronic apparatus that is yet another modified embodiment based on the preferred embodiment of the present invention.

### DESCRIPTION OF THE PREFERRED EMBODIMENTS

The following is a description in detail of the preferred embodiment of the present invention referring to the accompanying drawings.

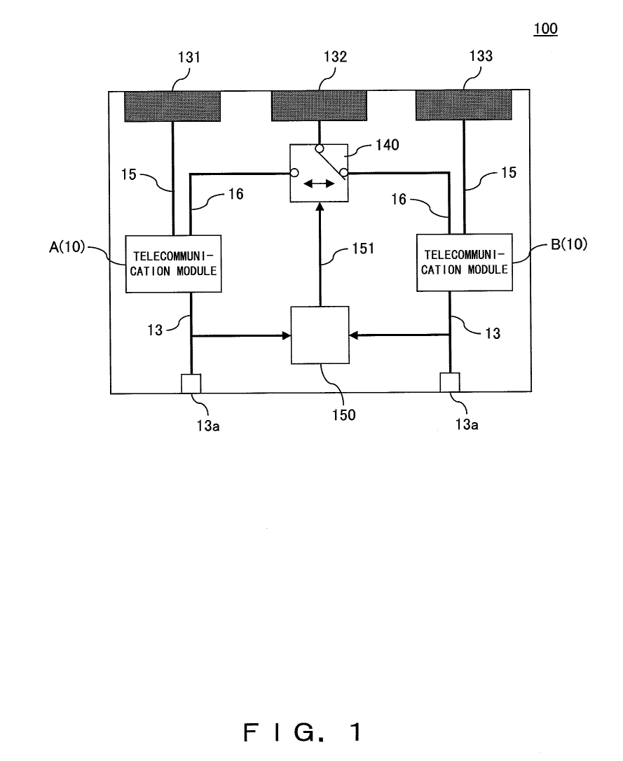

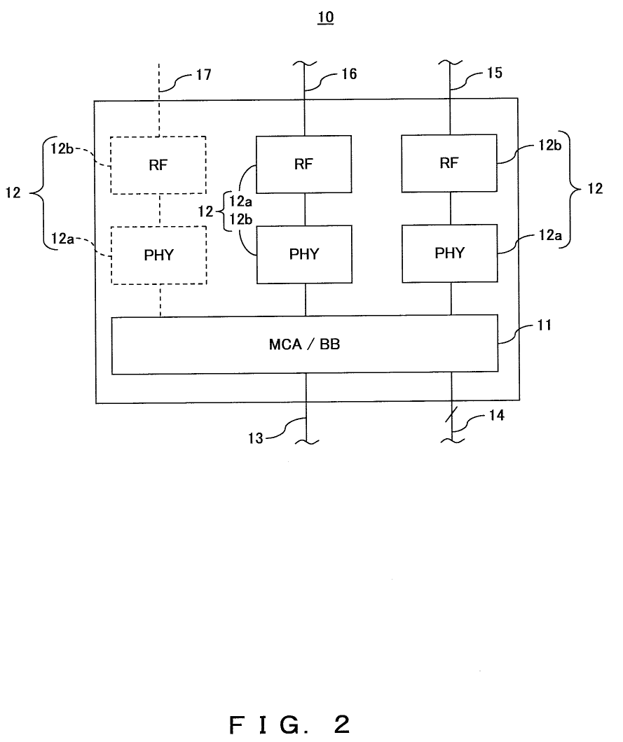

FIG. 1 is a block diagram exemplifying the configuration of an electronic apparatus according to the preferred embodiment of the present invention; and FIG. 2 is a block diagram exemplifying a part of the electronic apparatus, in further detail, according to the present embodiment.

Note that FIG. 1 exemplifies a part of the electronic apparatus 100 according to the present embodiment and may further comprise a user interface(s) such as a display, key board, speaker, microphone, and camera module as appropriate in addition to the constituent components exemplified in FIG. 1. The aforementioned premise is similar to the electronic apparatuses according to other modified embodiments described later.

The electronic apparatus 100 comprehends, for example, a portable computer, a stationary computer, a portable information terminal, a portable phone, and a game console.

The electronic apparatus 100 according to the present embodiment comprises a plurality of telecommunication modules, including telecommunication module A (i.e., a first telecommunication module) and telecommunication module B (i.e., a second telecommunication module), a plurality of antennas 131, 132 and 133, an antenna changeover switch 140 (i.e., a connection changeover unit), and a judgment circuit 150 (i.e., a connection changeover unit).

Telecommunication module A comprises a plurality of coaxial cables, including coaxial cable 15 and coaxial cable 16, with coaxial cable 15 being connected to antenna 131 and coaxial cable 16 being connected to antenna 132 by way of the antenna changeover switch 140.

Telecommunication module B comprises a plurality of coaxial cables, including coaxial cable 15 and coaxial cable 16, with coaxial cable 15 being connected to antenna 133 and coaxial cable 16 being connected to antenna 132 by way of the antenna changeover switch 140.

That is, antenna 131 is equipped specifically for telecommunication module A, and antenna 133 is equipped specifically for telecommunication module B. Meanwhile, antenna 132 is shared between the telecommunication modules A and B by way of the antenna changeover switch 140.

The antenna changeover switch 140 performs a changeover operation so that either one of the coaxial cables 16 of the telecommunication modules A or B is connected to the antenna 132.

Each of the telecommunication modules A and B turns on or off an LED 13a by way of an LED output-use signal 13, thereby externally displaying whether or not an individual module per se is in communication.

The judgment circuit 150 comprises a logic function for detecting the LED output-use signal 13 for each of the telecommunication modules A and B and discerning which of the two modules is in communication.

Then the judgment circuit 150 controls the above described changeover operation of the antenna changeover switch 140 by way of a switch control signal 151, thereby connecting the antenna 132 to either telecommunication module A or B, one of which is in communication.

FIG. 2 shows an example of the internal configuration of a telecommunication module 10 constituting both of the telecommunication modules A and B.

The telecommunication module 10 comprises a MAC/baseband process circuit 11, a plurality of analog front end units 12, a coaxial cable 15, and a coaxial cable 16.

The MAC/baseband process circuit 11 is equipped with, for example, a function for performing a baseband process and a protocol process for a Media Access Control (MAC) layer corresponding to the second layer of an Open Systems Interconnection (OSI) reference model. Further, the present embodiment is configured such that the MAC/baseband process circuit 11 is also equipped with a multi-input multi-output (MIMO) telecommunication function that uses a plurality of analog front end units 12 simultaneously.

Each of the analog front end units 12 comprises a physical layer process circuit 12a and a high-frequency transmission/reception circuit 12b.

The physical layer process circuit 12a is equipped with, for example, the function for processing a physical layer that is equivalent to the first layer of the OSI reference model.

The high-frequency transmission/reception circuit 12b is equipped with a transmission/reception process function for radio frequency waves.

Each of the analog front end units 12 is connected to external antennas by way of the coaxial cables 15 and 16, respectively.

That is, each one of the plurality of analog front end units 12 is connected to the antennas 131 and 132 by way of the coaxial cables 15 and 16, respectively, in the telecommunication module A.

Each one of the plurality of analog front end units 12 is connected to the antennas 133 and 132 by way of the coaxial cables 15 and 16, respectively, in the telecommunication module B.

The telecommunication module 10 is enabled for both standard telecommunication, by using one analog front end unit 12 (i.e., one antenna), and MIMO telecommunication, by using a plurality of analog front end units 12 (i.e., a plurality of antennas).

Next is a description of the operation of the present embodiment.

The following description is provided by exemplifying the case of, for example, the telecommunication module A carrying out a telecommunication through a wireless LAN and the telecommunication module B carrying out a portable phone telecommunication by means of the CDMA system.

The telecommunication module A, carrying out a telecommunication by way of a wireless LAN, controls the logic state of the LED output-use signal 13 so as to turn on the LED 13a when the module A is connected to an access point (not shown in a drawing herein) of the wireless LAN and to turn off the LED 13a when the module A is not connected thereto.

Meanwhile, the telecommunication module B, carrying out portable phone telecommunication, controls the LED output-use signal 13 so as to turn on the LED 13a during a dial-up connection (i.e., in communication) and to turn off the LED 13a when there is not a dial-up connection.

Then, the judgment circuit 150 monitors the state of the LED output-use signal 13 of each of the telecommunication modules A and B and controls the antenna changeover switch 140 by way of a switch control signal 151 so as to connect the antenna 132 to the telecommunication module A or B, in either of which the LED output-use signal 13 is in the state of turning on the LED 13a.

This configuration provides the telecommunication module A or B, either of which is in communication, with two times the number of antennas as a result of the antenna 132 being connected to the module per se.

As a result, for example, the telecommunication module A, presently carrying out telecommunications by way of a wireless LAN, is provided with approximately twice the telecommunication speed (i.e., the telecommunication capacity), by means of MIMO telecommunication, by simultaneously using two antennas, antenna 132 in addition to antenna 131, that are connected to the module.

Also, the telecommunication module B, carrying out portable phone telecommunications, is improved approximately twice as much in regards to telecommunication distance by means of MIMO telecommunication by simultaneously using two antennas, antenna 132 in addition to antenna 133, that are connected to the module. Further, having the two telecommunication paths by virtue of the antennas 133 and 132 makes it is possible to prevent a telecommunication interrupt during a phone conversation.

Further, sharing the antenna 132 by the telecommunication modules A and B by way of the antenna changeover switch 140, there is no unnecessary increase in the number of antennas.

That is, the electronic apparatus 100 enables improvement of telecommunication performance by means of a MIMO telecommunication in the telecommunication modules A and B without unnecessarily increasing the number of antennas.

In other words, the electronic apparatus 100 can be miniaturized in proportion to the installation space of an antenna.

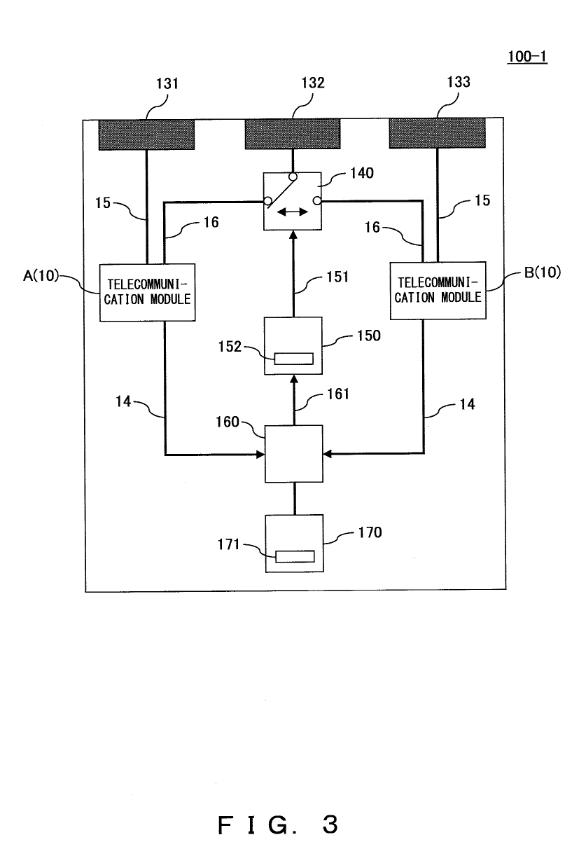

FIG. 3 is a conceptual diagram showing an electronic apparatus 100-1 which is a modified embodiment based on the present embodiment.

The electronic apparatus 100-1 which is a modified embodiment shown in FIG. 3 is configured to control the operation of an antenna changeover switch 140 by using a control signal 14 output from telecommunication modules 10 constituting telecommunication modules A and B.

The control signal 14 output from both of the telecommunication modules A and B is input into a microprocessor 160.

The microprocessor 160 controls a judgment circuit 150 by way of an I/O control signal 161 which is compliant with, for example, a general purpose I/O (GPIO) or the like.

That is, the judgment circuit 150 is equipped with an I/O register 152 that is compliant to, for example, the GPIO or the like. Further, the changeover operation of the antenna changeover switch 140, executed by the judgment circuit 150, is controlled by the microprocessor 160 that writes control data to the I/O register 152 by using an I/O control signal 161.

The microprocessor 160 controls the changeover operation of the antenna changeover switch 140 by executing a telecommunication control program 171 stored in memory 170.

That is, the control signal 14 input into the microprocessor 160 from both of the telecommunication modules A and B includes, for example, the information related to the telecommunication state (i.e., the telecommunication quality, such as the intensity of reception, of the radio frequency wave in both of the corresponding telecommunication modules A and B).

That is, the telecommunication state information SA of the control signal 14 is input from the telecommunication module A into the microprocessor 160. The telecommunication state information SA is a value proportionate to the intensity of reception of the radio frequency wave at the telecommunication module A.

Telecommunication state information SB of the control signal 14 is input from the telecommunication module B to the microprocessor 160. The telecommunication state information SB is a value proportionate to the intensity of reception of the radio frequency wave at the telecommunication module B.

The telecommunication control program 171 controls the antenna changeover switch 140 by way of the judgment circuit 150 so as to connect the antenna 132 to the telecommunication module A or B, for example, in either of which the intensity of reception of the radio wave input from the telecommunication modules A or B along with the control signal 14 is relatively weaker.

Alternatively, it is possible to connect the antenna 132 to telecommunication modules A or B on the basis of externally setup information or the like.

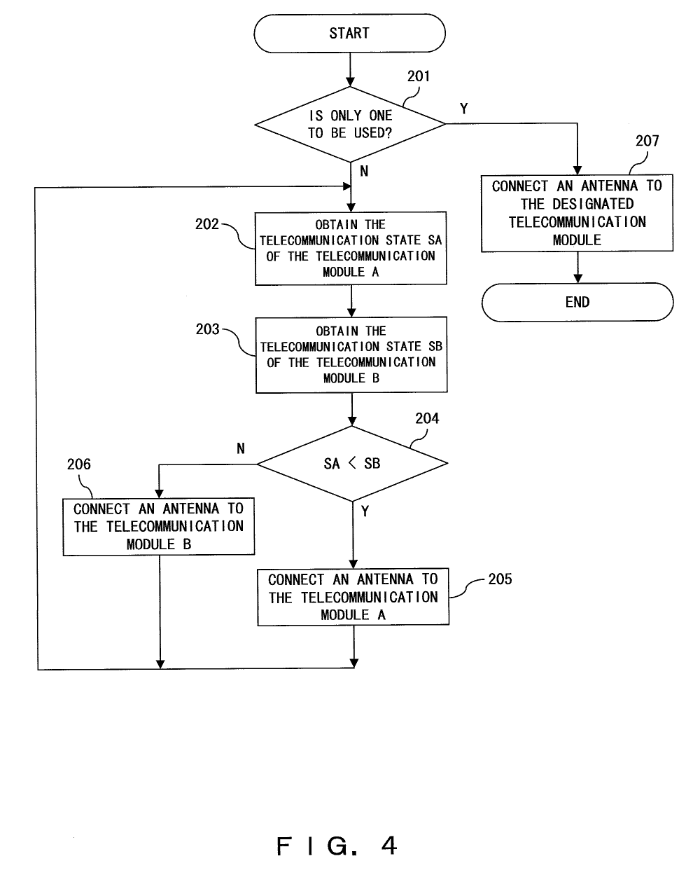

Next is a description of an example of the operation of the electronic apparatus 100-1 by referring to the flow chart shown in FIG. 4.

First, the telecommunication control program 171 discerns whether or not the use of only one of the telecommunication modules A or B is designated (step 201).

If it is not designated as such, the telecommunication state information SA of the telecommunication module A is obtained by using the control signal 14 input from the telecommunication module A (step 202).

The telecommunication control program 171 likewise obtains the telecommunication state information SB of the telecommunication module B by using the control signal 14 input therefrom (step 203).

Then, it judges the magnitudes between the telecommunication state information SA and telecommunication state information SB (step 204) and, if SA<SB, connects the antenna 132 to the telecommunication module A (step 205) so as to make the telecommunication module A carry out a MIMO telecommunication using the antennas 131 and 132 simultaneously.

If SA≧SB in the judgment of step 204, the telecommunication control program 171 connects the antenna 132 to the telecommunication module B (step 206) so as to make the telecommunication module B carry out a MIMO telecommunication using the antennas 133 and 132 simultaneously.

This changeover operation for connecting antenna 132 automatically improves the radio telecommunication condition of the telecommunication module A or B, in either of which the intensity of reception of the radio wave is weaker than in the other.

If the use of only one is judged in the above step 201, the antenna 132 is forcibly connected to the telecommunication module A or B, both of which are already set to be used (step 207).

This configuration makes it possible to select a telecommunication module with, for example, a lower telecommunication cost to give priority to carrying out a MIMO telecommunication if the telecommunication costs are different between the telecommunication modules A and B.

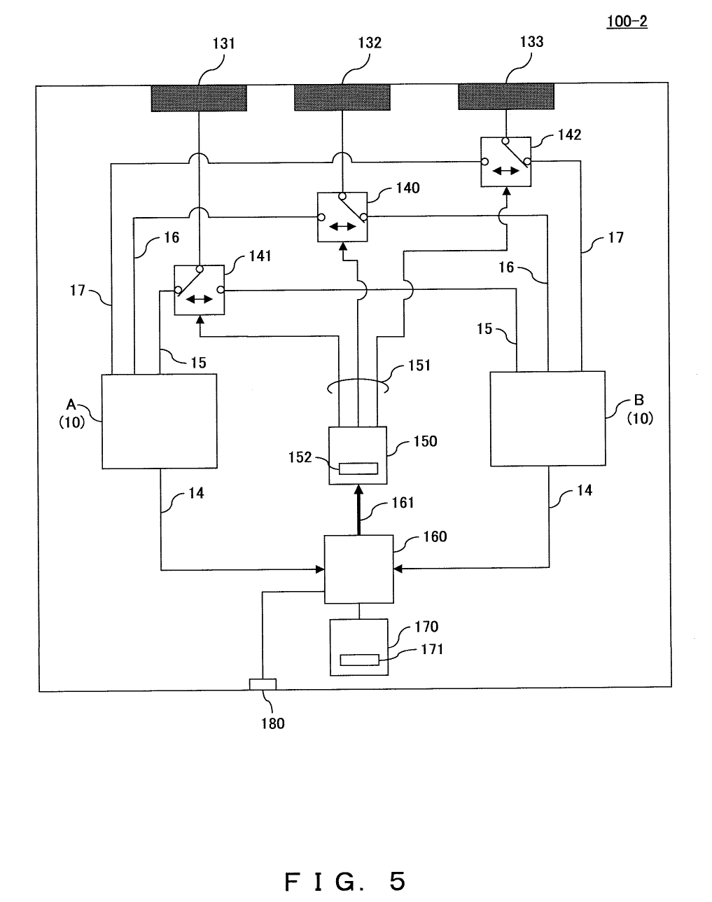

FIG. 5 is a conceptual diagram of an electronic apparatus 100-2, which is another modified embodiment according to the present embodiment. The modified embodiment shown in FIG. 5 is configured to selectively enable the connection of a plurality of antennas (i.e., three antennas, that is, antennas 131 through 133 in this example), equipped in the electronic apparatus 100-2, to the telecommunication module A or B.

That is, a telecommunication module 10, constituting both of the telecommunication modules A and B, comprises a plurality of analog front end units 12 (i.e., three units in this example) corresponding to the number of connectable antennas (i.e., three units in this example) and corresponding to three coaxial cables 15, 16 and 17.

The telecommunication module 10 is further equipped with antenna changeover switches 140, 141 and 142 respectively corresponding to the individual antennas 132, 131 and 133.

Then, the antenna changeover switch 140 connects the antenna 132 changeably to the coaxial cable 16 of the telecommunication module A or B.

The antenna changeover switch 141 connects the antenna 131 changeably to the coaxial cable 15 of the telecommunication module A or B.

The antenna changeover switch 142 connects the antenna 133 changeably to the coaxial cable 17 of the telecommunication module A or B.

Further, the electronic apparatus 100-2 is equipped with a mode setup switch 180 to enable a discretionary setup, as appropriate, as to which of the telecommunication modules A and B any of the antennas 131 through 133 is to be connected.

Note that the mode setup switch 180, in lieu of being implemented by hardware, may be implemented by a software switch which is controlled by means of software code such as a host operating system or an application program.

The mode setup switch 180 enables the setup of, for example, a number of modes as follows:

In a first mode, each of the antennas 131 through 133 is connected preferentially to either one of the telecommunication modules A and B designated by the mode setup switch 180.

In a second mode, two antennas are connected preferentially to one or the other of the telecommunication modules A or B designated by the mode setup switch 180, and the remaining one antenna is connected to the other module.

In a third mode, the antenna 131 is connected to the telecommunication module A, the antenna 133 is connected to the telecommunication module B, and the remaining antenna 132 is connected to either telecommunication module A or B, whichever is designated as higher priority by the mode setup switch 180.

In a fourth mode, the telecommunication control program 171 automatically determines which of the telecommunication modules A or B each of the antennas 131 through 133 is to be connected to.

In an example case in which the configuration is such that telecommunication module A carries out telecommunication by way of a wireless LAN and telecommunication module B carries out telecommunication by using a portable phone, and in which a wireless phone (e.g., an Internet Protocol (IP) phone) call via the wireless LAN of the telecommunication module A is also enabled, a phone call using telecommunication module A generally has a lower cost than a phone call using telecommunication module B.

In such a case, it is advantageous for a user to use telecommunication module A for phone calls as much as possible, and the present embodiment is accordingly configured to connect all of the antennas 131 through 133 to telecommunication module A, thereby accomplishing improved phone call stability and increased communicable distance.

Further, an automatic seamless changeover control between a phone call using telecommunication module A and that using telecommunication module B, in accordance with the telecommunication condition of each module, improves the operability of the user.

Next is a description of an example of the telecommunication control program 171 changing over the connection of the antennas 131 through 133 so as to continue the phone call at the low-cost telecommunication module A as long as possible in the above described case.

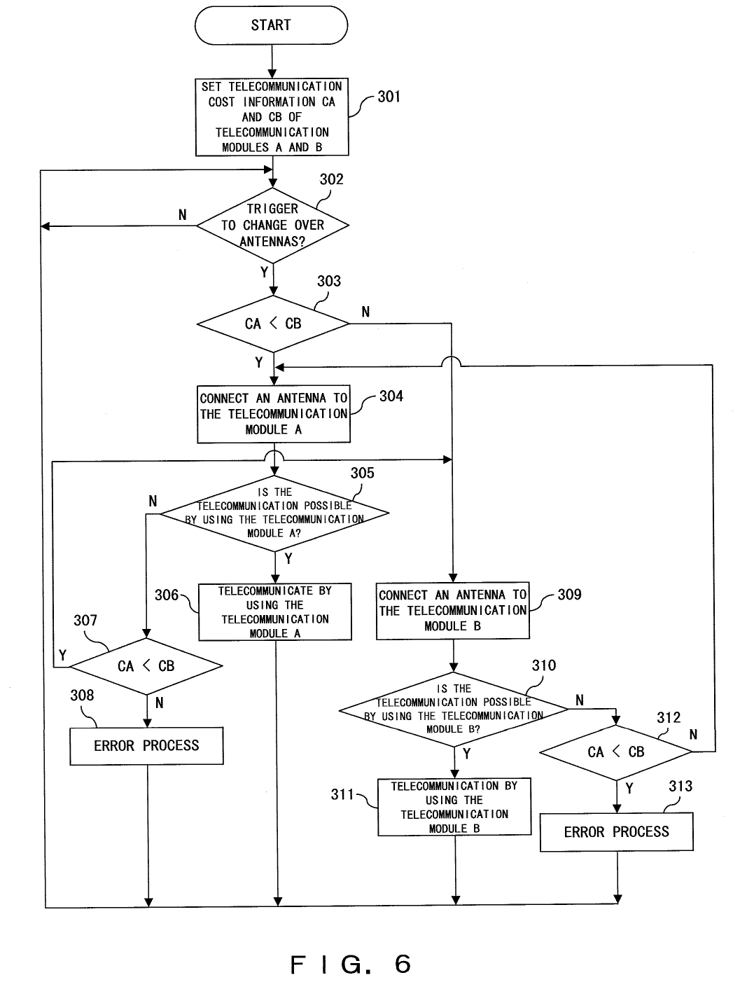

FIG. 6 is a flow chart exemplifying the control operation of the telecommunication control program 171.

Note that the phone call cost when using telecommunication module A is defined as the telecommunication cost information CA, and the phone call cost when using telecommunication module B is defined as the telecommunication cost information CB.

First, the telecommunication control program 171 sets the telecommunication cost information CA and telecommunication cost information CB to, for example, a portion of the memory 170 (step 301).

Then, the program 171 discerns whether there is a trigger to change over the antennas 131 through 133 (step 302). That is, an unlimited number of occurrences of changing over of the connections of the antennas 131 through 133 can conceivably cause the telecommunication to be unstable. The present embodiment is accordingly configured to consider an optimum point in time for a changeover trigger, for example, a break during a phone call.

Then, if it discerns a trigger for a changeover, the telecommunication control program 171 discerns the magnitudes between the telecommunication cost information CA and CB (step 303).

If CA<CB, it connects all of the antennas 131 through 133 to the telecommunication module A so as to prioritize it (step 304), then examines the telecommunication state of the telecommunication module A, discerns whether or not the present module A is communicable (step 305) and, if the module A is discerned to be communicable, carries out a phone call by using the telecommunication module A (step 306).

If it is judged in the above step 305 that the present module A is incommunicable, then whether or not CA<CB applies, that is, whether or not the present module A has initially been selected is discerned (step 307).

If CA<CB is judged to apply in step 307, that is, if the telecommunication module A has initially been selected, all of the antennas 131 through 133 are connected to the yet-to-be-tried telecommunication module B (step 309).

Then the telecommunication control program 171 discerns whether or not it is communicable by using telecommunication module B (step 310) and, if it is communicable, carries out a phone call by using telecommunication module B (step 311).

If telecommunication module B is judged to be incommunicable in step 310, then whether or not CA<CB applies, that is, whether or not telecommunication module A has initially been selected (i.e., whether or not module A has already been tried to be used) is discerned (step 312).

In this case, since the telecommunication module A is already attempting to be used, neither telecommunication module A nor B is communicable, and the necessary error process is accordingly carried out (step 313), followed by the process returning to step 302.

Likewise, if CA<CB is judged to not apply in the above noted step 307, neither telecommunication module A nor B is communicable since the other telecommunication module, module B, has already been tried, and the necessary error process is accordingly carried out (step 308), followed by the process returning to step 302.

As described above, the control shown in the flow chart of FIG. 6 attempts telecommunication (i.e., a phone call) by connecting all of the antennas 131 through 133 preferentially to the telecommunication module A or B, in either of which the telecommunication cost is lower. Because of this configuration, it is possible to automatically suppress the phone call (i.e., the telecommunication) cost to a minimum in an environment where a phone call is made by seamlessly changing over between the telecommunication modules A and B.

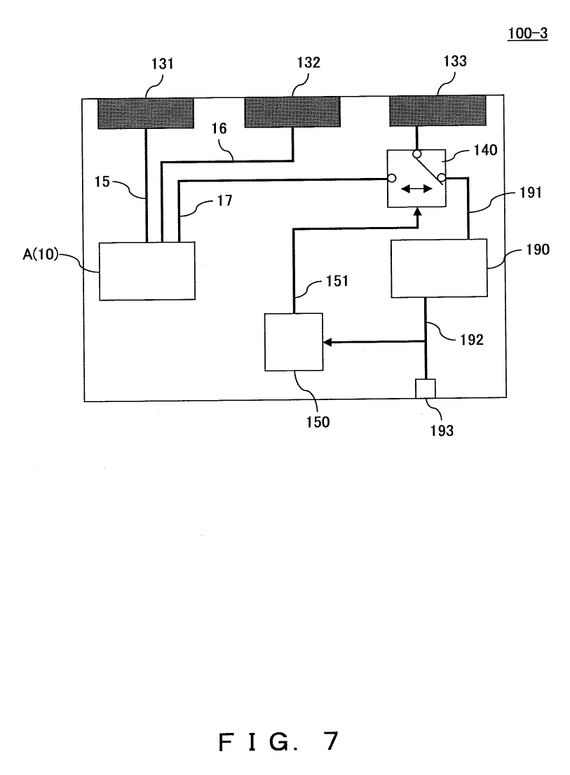

FIG. 7 is a conceptual diagram showing an electronic apparatus 100-3 which is yet another modified embodiment according to the present embodiment.

The electronic apparatus 100-3 comprises a telecommunication module A, a radio reception apparatus 190, a plurality of antennas 131 through 133, an antenna changeover switch 140, and a judgment circuit 150. The telecommunication module A is constituted by the above described telecommunication module 10 that is connected to a plurality of antennas 131 and 132 by way of coaxial cables 15 and 16. The telecommunication module A is also connected to an antenna 133 by way of a coaxial cable 17 and of an antenna changeover switch 140.

The radio reception apparatus 190 may be, for example, a Global Positioning System (GPS) receiver or a broadcast receiver for a radio broadcast, television broadcast, or the like. The radio reception apparatus 190, being connected to the antenna 133 by way of the coaxial cable 191 and antenna changeover switch 140, operates by receiving radio waves from the antenna 133.

The radio reception apparatus 190 outputs an LED output-use signal 192 for externally displaying the presence or absence of an operation by turning on or off an LED 193.

The judgment circuit 150 monitors the LED output-use signal 192, and operates the antenna changeover switch 140 to connect the antenna 133 to the radio reception apparatus 190 when the radio reception apparatus 190 is in operation.

If the radio reception apparatus 190 is not in operation, the judgment circuit 150 operates the antenna changeover switch 140 to connect the antenna 133 to the telecommunication module A so that the number of antennas usable for a MIMO telecommunication at the telecommunication module A increases from two, i.e., the antennas 131 and 132, to three, i.e., the antennas 131 through 133 and thereby accomplishes enhancement of telecommunication capacity.

Note here, it must be clear that the present invention may be changed in various manners possible within the scope of the present invention, and it is not limited to the configurations exemplified in the above described preferred embodiments.

It must be clear that, for example, the number of telecommunication modules comprised by an electronic apparatus may be three or more.

Further, a MIMO telecommunication function compliant to a WiMAX (per the IEEE 802.16a) and to a Ultra Wide Band (UWB) may be incorporated as the telecommunication function of a telecommunication module, and the present invention is not limited to the above described telecommunication function compliant to the wireless LAN and CDMA system.

The incorporation of a plurality of wireless functions is required in keeping pace with the further diversification of wireless telecommunications in the future. Associated with the wireless devices corresponding to the MIMO system for improving the telecommunication performance becoming the mainstream, the number of built-in antennas further increases.

Under such a situation, there is a great significance of the present invention in providing a technique in which some or all of the antennas are shared in order to reduce the number of antennas built-in in an electronic apparatus and in which the operation condition of each wireless device is automatically judged to maintain roaming between a plurality of different wireless devices (i.e., telecommunication modules) and maintain a stable telecommunication state, and thereby the shared antennas are changed over and used.

What is claimed is:

1. An electronic apparatus, comprising:
a plurality of antennas;
a first telecommunication module and a second telecommunication module, either of which, at minimum, performs radio telecommunications by simultaneously using a plurality of antennas from among the plurality of antennas; and
a connection changeover unit for changing over connections so that at least one of the antennas is connected to either of the first or second telecommunication module.

2. The electronic apparatus according to claim 1, wherein
the connection changeover unit connects the at least one antenna to the first or second telecommunication module, either of which is judged to be in communication on the basis of an operation display signal indicating whether each of the first and second telecommunication modules is in communication.

3. The electronic apparatus according to claim 1, wherein
the connection changeover unit connects the at least one antenna to the first or second telecommunication module, in either of which telecommunication quality is judged to be inferior on the basis of telecommunication quality information indicating the telecommunication quality in each of the first and second telecommunication modules.

4. The electronic apparatus according to claim 1, further comprising
a priority order setup unit for setting a priority order of the first and second telecommunication modules, wherein
the connection changeover unit connects the at least one antenna to the first or second telecommunication module, whichever is higher in the priority order.

5. The electronic apparatus according to claim 1, wherein
the first telecommunication module is a wireless local area network telecommunication module equipped with a multi-input multi-output radio telecommunication function and the second telecommunication module is a portable telephone-use telecommunication module equipped with a multi-input multi-output radio telecommunication function.

6. The electronic apparatus according to claim 1, wherein
the first telecommunication module is a multi-input multi-output radio telecommunication apparatus performing radio telecommunications by means of the MIMO system and the second telecommunication module is a global positioning system reception apparatus or a broadcast reception apparatus, wherein
the connection changeover unit changes the connection of the at least one antenna, when the at least one antenna is connected to the second telecommunication module but the second telecommunication module is not being used, to the first telecommunication module.

7. A control method for an electronic apparatus, comprising:
a first step for detecting the operation states of a first telecommunication module and of a second telecommunication module, either of which, at minimum, performs radio telecommunications by simultaneously using a plurality of antennas for transmitting and receiving data; and
a second step for connecting an antenna shared by the first and second telecommunication modules to the first or second telecommunication module in accordance with the operation states.

8. The control method for an electronic apparatus according to claim 7, wherein
an operation display signal indicating whether or not each of the first and second telecommunication modules is in communication is detected as the operation state in the first step, and
the antenna is connected to the first or second telecommunication module, either of which is judged to be in communication in the second step.

9. The control method for an electronic apparatus according to claim 7, wherein
telecommunication quality information indicating the telecommunication quality in each of the first and second telecommunication modules is detected as the operation state in the first step, and
the antenna is connected to the first or second telecommunication module, either of which is judged to be inferior in telecommunication quality in the second step.

10. The control method for an electronic apparatus according to claim 7, wherein
a telecommunication cost of each of the first and second telecommunication modules is detected as the operation state in the first step, and
the antenna is connected, with a higher priority, to the first or second telecommunication module, one of which has a lower telecommunication cost in the second step.

11. The control method for an electronic apparatus according to claim 7, wherein
the first telecommunication module is a multi-input multi-output radio telecommunication apparatus performing a radio telecommunication by means of the multi-input multi-output system, and the second telecommunication module is a global positioning system reception apparatus or a broadcast reception apparatus, wherein
whether or not the second telecommunication module is in use is discerned in the first step, and
the antenna, connected to the second telecommunication module, is changed over to connect to the first telecommunication module if the second telecommunication module is judged not to be in use in the second step.

12. A computer-readable storage medium storing a control program for use in an electronic apparatus that comprises a first telecommunication module and a second telecommunication module, either of which, at minimum, performs radio telecommunications by simultaneously using a plurality of antennas for transmitting and receiving data, wherein
the control program makes the electronic apparatus execute
a first step for detecting operation states of the first and second telecommunication modules, and
a second step for connecting an antenna shared by the first and second telecommunication modules to the first or second telecommunication module in accordance with the operation states.

13. The storage medium according to claim 12, wherein
telecommunication quality information, indicating the telecommunication quality in each of the first and second telecommunication modules, is detected as the operation state in the first step, and
the antenna is connected to the first or second telecommunication module, either of which is judged to be inferior in telecommunication quality in the second step.

14. The storage medium according to claim 12, wherein
a telecommunication cost of each of the first and second telecommunication modules is detected as the operation state in the first step, and
the antenna is connected, with a higher priority, to the first or second telecommunication module, one of which has a lower telecommunication cost in the second step.
